(19) United States
(12) Patent Application Publication
(10) Pub. No.: US 2023/0212350 A1
(43) Pub. Date: Jul. 6, 2023

(54) A METHOD FOR MANUFACTURING AN OLIGOMERIC POLYETHYLENE TEREPHTHALATE (PET) SUBSTRATE

(71) Applicant: Koch Technology Solutions, LLC, Wichita, KS (US)

(72) Inventors: Clive Alexander HAMILTON, North Yorkshire (GB); George Malcolm WILLIAMSON, Wilmington, NC (US)

(73) Assignee: Koch Technology Solutions, LLC, Wichita, KS (US)

(21) Appl. No.: 17/927,366

(22) PCT Filed: Jun. 2, 2021
(86) PCT No.: PCT/IB2021/054843

§ 371 Date: Nov. 23, 2022

Related U.S. Application Data
(60) Provisional application No. 63/035,186, filed on Jun. 5, 2020.

(51) Int. Cl. C08G 63/86; C08G 63/83; C08G 63/183

(52) U.S. Cl. CPC C08G 63/866; C08G 63/83; C08G 63/183

(57) ABSTRACT

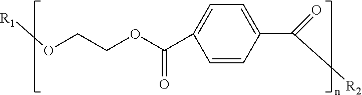

A method for producing an oligomeric polyethylene terephthalate (PET) substrate for use in a recycled PET (rPET) manufacturing process comprises adding recycled bis-hydroxylethyleneterephthalate (rBHET) or a higher molecular weight oligomer derived from rBHET and water to a reaction zone and reacting the rBHET and water in the reaction zone to produce an oligomeric PET substrate represented by the Formula (I): wherein R1 is a carboxyl end group or a hydroxyl end group, R2 is a carboxyl end group or a hydroxyl end group, and n is a degree of polymerisation (Dp).

### CROSS-REFERENCE TO RELATED APPLICATIONS

This application claims the benefit of U.S. Provisional Application No. 63/035,186, filed Jun. 5, 2020, the disclosure of which is incorporated herein by reference in its entirety.

### FIELD

The present disclosure relates to methods for manufacturing an oligomeric PET substrate from either recycled bis-hydroxylethyleneterephthalate (rBHET) or from virgin BHET (vBHET) derived from virgin dimethylterephthalate (vDMT), an oligomeric PET substrate for use in manufacturing recycled PET and also PET polymer made from 0-100% recycled PET which includes the oligomeric PET substrate, where 0% recycled PET represents PET polymer from vDMT.

### BACKGROUND

PET (polyethylene terephthalate) is a synthetic material that was first made in the mid-1940s. PET has desirable properties and processing abilities and hence is now used extensively on a global scale for packaging applications in the food and beverage industries and for industrial products, as well as in the textile industry.

Typically, PET has petrochemical origins. Purified terephthalic acid is first formed via aerobic catalytic oxidation of p-xylene in acetic acid medium in a purified terephthalic acid manufacturing facility. This purified terephthalic acid (PTA) is subsequently reacted with ethylene glycol to produce a PTA-based oligomer (and water), which polycondenses to form PET polymer. An alternative route to PET polymer is via polymerisation of a bis-hydroxylethyleneterephthalate (BHET) monomer, although this route is less favorable from a process economic point of view. The BHET monomer is formed through the reaction of dimethylterephthalate (DMT) (a diester formed from terephthalic acid and methanol) with ethylene glycol, and then the BHET monomer polymerises with itself to form longer chains of PET.

In a PET manufacturing process, there are three main stages in the melt-phase process to make the PET polymer: (1) esterification, (2) pre-polymerisation, and (3) polymerisation. When making PET resin, the PET polymer enters a further solid-state polymerisation (SSP) stage to make further changes which include increasing the molecular weight of the polymer. In the initial esterification stage, the PTA (or DMT) and ethylene glycol are mixed and fed into an esterification unit, where esterification, which may be catalyzed or uncatalyzed, takes place under atmospheric pressure and a temperature in the range of 270° C. to 295° C. Water (or methanol in the case of DMT) resulting from the esterification reaction and excess ethylene glycol are vaporised. Additives, including catalysts and toners, are typically added to the process in between the esterification stage and the subsequent pre-polymerisation stage. In the pre-polymerisation stage, the product from the esterification unit is sent to the pre-polymerisation unit and reacted with extra ethylene glycol at a temperature in the range of 270° C. to 295° C. under significantly reduced pressure to allow the degree of polymerisation of the oligomer to increase. During the polymerisation stage, the product from the pre-polymerisation stage is again subjected to low pressures and a temperature in the range of 270° C. to 295° C. in a horizontal polymerisation unit to further allow an increase in the degree of polymerisation to approximately 80-120 repeat units. In embodiments, this is referred to as the Finisher or Finisher vessel. When making PET resin, a fourth, solid-state polymerisation (SSP) stage is usually required involving a crystallisation step wherein the amorphous pellets produced in the melt phase process are converted to crystalline pellets, which are then subsequently processed further depending on the final PET product, which may be as diverse as containers/bottles for liquids and foods, or industrial products and resins.

It is desirable to recycle post-consumer PET-containing waste material to reduce the amount of plastic sent to landfill. One known recycling method is to take post-consumer PET-containing waste material to produce post-consumer recycled (PCR) flake. This PCR flake may be glycolysed to convert it to recycled bis-hydroxylethyleneterephthalate (rBHET). This rBHET can then be used in a PET manufacturing process to make recycled PET (rPET; so-called because the oligomer upon which it is based is derived from post-consumer PET or PCR, rather than PTA or DMT). This circumvents the need to use more PTA with petrochemical origins, in combination with ethylene glycol, to make a PTA-based oligomer in a virgin (vPTA) process or to make virgin (vBHET) in a virgin (vDMT) process. In addition, since lower amounts of petrochemicals are required to make recycled PET (rPET) as compared to new PET, known as virgin PET (vPET), rPET consequently has a lower carbon footprint than vPET. Therefore, rPET is attractive based on its ‘green’ credentials, which themselves may confer economic benefits in certain jurisdictions.

However, rPET made from rBHET tends to have lower reactivity in the melt phase process and in the solid phase polymerisation stage. If rBHET is used in a PET manufacturing process, the amount of rPET manufactured is approximately 20% lower than if a PTA-based oligomer is used (i.e., short-chain PET oligomers made through esterification of purified terephthalic acid with ethylene glycol). Further still, rPET made from rBHET tends to be darker (lower L*) and more yellow, which is mainly due to impurities present in the rPET polymer. At present, therefore, rPET manufacturing processes using rBHET (glycolysis product of PET waste) are neither attractive nor competitive when compared with vPET processes using a PTA-based oligomer or vBHET.

Therefore, there exists a need to produce an oligomeric PET substrate which has an increased reactivity and consequently increased ability to polymerise to form rPET in order to compete with processes making vPET.

### SUMMARY OF INVENTION

The present disclosure provides, inter alia, a method for producing an oligomeric PET substrate for use in a rPET manufacturing process, the method comprising reacting bis-hydroxylethyleneterephthalate (rBHET) from either a recycled source or from vDMT, or a higher molecular weight oligomer derived from a similar BHET source with water to produce an oligomeric PET substrate represented by Formula I:

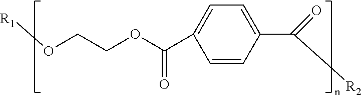

wherein R1 is a carboxyl end group (COOH) or a hydroxyl end group (OH), R2 is a carboxyl end group or a hydroxyl end group, and n is a degree of polymerisation.

In some embodiments, when the method comprises reacting rBHET with water, n is 1 to 10, preferably 3 to 7. In some embodiments, when the method comprises reacting a higher molecular weight oligomer derived from rBHET with water, n is 20 to 50, preferably 25 to 35. In some embodiments, when the method comprises reacting rBHET with water, the oligomeric PET substrate has a CEG (mols acid ends/te of material) of from 300 to 1500, preferably from 500 to 1200, more preferably from 700 to 1100. In some embodiments, when the method comprises reacting a higher molecular weight oligomer derived from rBHET with water, the oligomeric PET substrate has a CEG (mols acid ends/te of material) of from 40 to 200, preferably from 150 to 190. In some embodiments, the oligomeric PET substrate has a hydroxyl end group: carboxyl end group ratio in a range of 1.66 to 6.66, preferably in a range of 2.22 to 4.0.

In some embodiments, when the method comprises reacting rBHET with water, the water is added to the reaction zone in a range of 2 wt % and 20 wt %, preferably is in a range of 5 wt % to 10 wt % with respect to PET polymer. In some embodiments, when the method comprises reacting a higher molecular weight oligomer derived from rBHET with water, the water is added to the reaction zone in a range of 0.1 wt % and 2 wt %, preferably in a range of 0.1 wt % to 0.5 wt % with respect to PET polymer. In some embodiments, the rBHET is reacted with water at a temperature between 120° C. to 300° C., preferably from 150° C. to 270° C. In some embodiments, the higher molecular weight oligomer derived from rBHET is reacted with water at a temperature from 270° C. to 300° C., preferably from 285° C. to 295° C. In some embodiments, the method comprises a residence time in the reaction zone of between 30 minutes to 120 minutes, preferably from 40 to 50 minutes. In some embodiments, the rBHET is reacted with water at a pressure between 3 barg to 30 barg. In some embodiments, the higher molecular weight oligomer derived from rBHET is reacted with water at a pressure of between 10 barg to 50 barg.

In some embodiments, the rBHET or a higher molecular weight oligomer derived from rBHET is reacted with water using at least one exogenously added catalyst selected from an antimony-containing catalyst, titanium-containing catalyst, a zinc-containing catalyst, an acetate-containing catalyst, a manganese-containing catalyst, a germanium-containing catalyst, an aluminium-containing catalyst and a tin-containing catalyst. In some embodiments, the catalyst comprises at least one of antimony trioxide, antimony glycolate, antimony triacetate, titanium alkoxide, zinc acetate and manganese acetate. In some embodiments, the oligomeric PET substrate is fed directly or indirectly into said rPET manufacturing process.

The present disclosure also provides a PET substrate produced by a method described herein. In an embodiment, the oligomeric PET substrate has a structure according to Formula I:

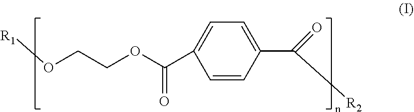

wherein R₁ is a carboxyl end group or a hydroxyl end group, R₂ is a carboxyl end group or a hydroxyl end group, and n is a degree of polymerisation, and wherein the oligomeric PET substrate further comprises any two of the following characteristics: i) n is a degree of polymerisation of 1-10 or 20-50; ii) a carboxyl acid end group concentration (CEG) (mols acid ends/metric ton (te) of material) of between from 300 to 1500 or 40 to 200; and iii) a hydroxyl end group: carboxyl end group ratio in the range of 1.66 to 6.66. In some embodiments, the oligomeric PET substrate is used in synthesis of a polymer in a range of 0-100% rPET.

The present disclosure also provides a PET polymer made from 0-100% rPET, produced from the oligomeric PET substrate as represented by Formula I.

### BRIEF DESCRIPTION OF THE FIGURES

FIG. 1 is a flowsheet schematic according to the process disclosed herein showing the location where rBHET and water can be added to an rBHET process.

FIG. 2 is a flowsheet schematic according to the process disclosed herein showing the location where water can be added later in the process to the oligomer exiting the pre-polymerisation vessel (UFPP).

FIG. 3 is an alternative flowsheet schematic according to the process disclosed herein showing the location where water can be added later in the process to the oligomer exiting the pre-polymerisation vessel (UFPP).

FIG. 4 is typical laboratory apparatus designed to demonstrate the hydrolysis of BHET from a DMT transesterification reaction.

FIG. 5 is a flowsheet schematic according to the process disclosed herein showing the location where water can be added to BHET made from a DMT process.

FIG. 6 is an alternative flowsheet schematic according to the process disclosed herein showing the location where water can be added to BHET made from a DMT process.

FIG. 7 is a graph illustrating finisher pressure as a function of the oligomer OH:COOH ratio in accordance with the simulated process of producing PET described in Comparative Example 5.

FIG. 8 is a graph illustrating plant rate as a function of the oligomer OH:COOH ratio in accordance with the simulated process of producing PET described in Comparative Example 5.

FIG. 9 is a graph illustrating finisher pressure against % H₂O in accordance with aspects of the present disclosure in accordance with the simulated process of producing PET described in Example 7.

FIG. 10 is a graph illustrating finisher pressure against the oligomer OH:COOH in accordance with the simulated process of producing PET described in Example 7.

### DETAILED DESCRIPTION

Disclosed herein are methods to produce an oligomeric PET substrate from rBHET or a higher molecular weight oligomer derived from BHET, an oligomeric PET substrate for use in manufacturing rPET, and a PET polymer made from a range of 0-100% recycled PET which includes the oligomeric PET substrate. In the methods of the present disclosure, rBHET or a higher molecular weight oligomer derived from BHET and water are added to a reaction zone and reacted in the reaction zone under conditions effective to produce the oligomeric PET substrate.

The methods disclosed herein address a problem recognized in the art with respect to the lower reactivity of rBHET as compared to vBHET in the manufacturing of PET oligomers and the consequentially lower yields of PET oligomers prepared from rBHET as compared to PET oligomers prepared from vBHET or PTA. In particular, the disclosure provides a means to improve the efficiency of rPET manufacturing by reacting BHET or a higher molecular weight oligomer derived from BHET with water at specific points in the manufacturing process. These methods increase the ability of practitioners to prepare PET from recycled starting materials in a manner that is economically competitive with methods for preparing virgin PET.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. In case of conflict, the present specification, including definitions, will control.

In addition, the materials, methods, and examples are illustrative only and not intended to be limiting. The details of one or more embodiments of the invention are set forth in the accompanying drawings and the description below. Other features, objects, and advantages of the invention will be apparent from the description and the drawings, and from the claims. The word “comprising” in the claims may be replaced by “consisting essentially of” or with “consisting of,” according to standard practice in patent law.

Unless specifically stated otherwise or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The term “PET” or “PET polymer” refers to polyethylene terephthalate.

The term “PTA” refers to purified terephthalic acid.

The term “vPTA” refers to PTA synthesised via aerobic catalytic oxidation of p-xylene in acetic acid medium.

As used herein, “PTA-based oligomer” refers to a short-chain PET oligomer synthesised through a process requiring esterification of purified terephthalic acid with ethylene glycol. Purified terephthalic acid (PTA) is reacted with ethylene glycol to produce the PTA-based oligomer (and water), which polycondenses to form PET polymer. When PTA is reacted with ethylene glycol, a short chain PTA-based oligomer is formed which is characterised by a Dp (degree of polymerisation or number of repeat units) and a CEG (or carboxyl acid end group concentration). The degree of polymerisation (Dp) is calculated from the number average molecular weight Mn by the following formula: Dp=(Mn−62)/192, in which Mn is calculated by rearranging the following correlation for IV (intrinsic viscosity): IV=1.7e-4 (Mn)^{0.83}. The intrinsic viscosity (IV) of the polyester can be measured by a melt viscosity technique equivalent to ASTM D4603-96. Typically, for a PTA-based oligomer formed by reacting PTA with ethylene glycol, the degree of polymerisation is usually between 3 and 7 and the CEG is usually between 500 and 1200 (mols acid ends/te of material). The hydroxyl end group (HEG) ratio to carboxyl end group (CEG) is determined from the CEG measurement and the rearrangement of following calculation of Mn: Mn=2e6/(CEG+HEG).

As used herein, “PET manufacturing process” refers to a facility that produces PET. Such a facility may be integrated with a PTA manufacturing process or may be entirely independent.

As used herein, “post-consumer PET-containing waste material,” refers to any waste stream that contains at least 10% PET waste. The post-consumer PET-containing waste materia” may therefore include 10% to 100% PET. The post-consumer PET-containing waste material may be municipal waste which itself includes at least 10% PET waste, such as PET plastic bottles or PET food packaging or any consumer recycled PET-containing waste material such as waste polyester fibre. Waste polyester fibre sources include items such as clothing items (shirts, trousers, dresses, coats, etc.), bed linen, duvet linings or towels. The “post-consumer PET-containing waste material” may further include post-consumer recycled (PCR) flake, which is waste PET plastic bottles which have been mechanically broken into small pieces in order to be used in a recycling process.

As used herein, “vPET” refers to virgin PET, which is PET synthesised through a process requiring esterification of purified terephthalic acid with ethylene glycol. The purified terephthalic acid (PTA) is reacted with ethylene glycol to produce a PTA-based oligomer (and water), which polycondenses to form PET polymer. Alternatively, vPET may be formed through the reaction of dimethylterephthalate (DMT) (a diester formed from terephthalic acid and methanol) with ethylene glycol. A BHET monomer is formed through the reaction of dimethylterephthalate (DMT) (a diester formed from terephthalic acid and methanol) with ethylene glycol, and then the BHET monomer polymerises with itself to form longer chains of PET.

As used herein, “rPET” refers to recycled PET, which is PET manufactured entirely or at least partially from oligomers that have been derived from post-consumer PET-containing waste material. The rPET may be synthesised from oligomers that are 100% derived from a post-consumer PET-containing waste material. Alternatively, the rPET may be synthesised from a combination of oligomers which include those derived from post-consumer PET-containing waste material and also those from vBHET or PTA-based oligomers used to make vPET. In one non-limiting embodiment, the rPET includes at least 5% oligomeric PET substrate derived from post-consumer PET-containing waste material. In another non-limiting embodiment, the rPET includes at least 50% oligomeric PET substrate derived from post-consumer PET-containing waste material. In yet another non-limiting embodiment, the rPET includes at least 80% oligomeric PET substrate derived from post-consumer PET-containing waste material.

As used herein, “rPET manufacturing process” refers to both manufacturing processes and facilities that have been purposely designed and built to synthesise recycled PET (rPET), namely PET from substrates that include those derived from any post-consumer PET-containing waste material in addition to virgin substrates (i.e. vBHET or PTA-based oligomer), and also manufacturing processes and facilities that were built to synthesise vPET but which have been modified or retrofitted to allow the production of rPET. Changes that are required to a vPET facility in order to produce rPET are typically not major structurally but instead require a number of process changes.

The term “BHET” refers to the bis-hydroxylethyleneterephthalate monomer (C₁₂H₁₄O₆), including all structural isomers, which is characterised as having no carboxyl end groups, namely a carboxyl acid end group concentration (CEG) of zero. The chemical structure of the para-isomer of the BHET monomer is represented below:

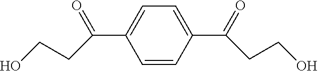 [SMILES: O=C(CCO)c1ccc(C(=O)CCO)cc1]

To produce PET, BHET reacts with itself to make longer chains in a polycondensation reaction, thereby forming polyethylene terephthalate and liberating ethylene glycol in the process. BHET, namely the BHET monomer, is typically formed through reaction of dimethylterephthalate (DMT) with ethylene glycol but it is also a minor component of the oligomer made from PTA plus ethylene glycol, i.e. part of the oligomeric molecular weight distribution. When PTA is reacted with ethylene glycol, a short chain PTA-based oligomer is formed which is characterised by a Dp (degree of polymerisation or number of repeat units) and a CEG (or carboxyl acid end group concentration). Typically, for a PTA-based oligomer formed by reacting PTA with ethylene glycol, the degree of polymerisation is usually between 3 and 7 or between 25 to 35 and the CEG is usually between 500 and 1200 or between 150 and 190 (mols acid ends/te of material).

The term “vBHET” refers to virgin BHET, which is the BHET monomer formed through reaction of dimethylterephthalate (DMT) with ethylene glycol.

The term “rBHET” refers to recycled BHET, which is the BHET molecule produced by glycolyzing PET. Post-consumer PET-containing waste material, such as PET plastic bottles, is mechanically broken down to produce post-consumer recycled (PCR) flake. This PCR flake is then glycolysed to convert it to rBHET.

As used herein, “oligomeric PET substrate” refers to a molecule according to Formula I:

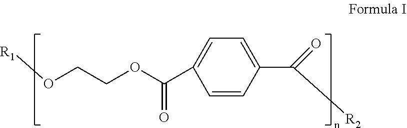

Either end of Formula I may be a carboxyl end group (COOH) or a hydroxyl end group (OH). Therefore, either R₁ or R₂ may be a carboxyl end group or a hydroxyl end group. The optimum ratio of hydroxyl end group: carboxyl end group (HEG:CEG) in the oligomeric PET substrate is typically between 1.66 and 6.66. Formula I polymerises with itself in an esterification reaction, in which carboxyl end groups react with hydroxyl end groups to form an ester link, liberating water. The “n” represents the degree of polymerisation (Dp) or number of repeat units of Formula I that exist in the oligomeric PET substrate and may, for example, be between 3 and 7 or between 25 and 35. In addition to being characterised by the degree of polymerisation (Dp), the oligomeric PET substrate is also characterised by its carboxyl acid end group concentration, referred to herein as CEG. The CEG (units are mols acid ends/te of material) may, for example, be between 500 and 1200 or between 150 and 190.

Aspects of the present disclosure provide methods to produce an oligomeric PET substrate. Approaches to produce rPET have typically used the process of glycolyzing PET (or waste sources having PET) using for example, ethylene glycol, to produce bis-hydroxylethyleneterephthalate (rBHET). This approach to producing rPET uses rBHET and polymerises it to produce rPET. However, this rBHET has a lower reactivity as compared to a PTA-based oligomer formed through an esterification reaction of purified terephthalic acid with ethylene glycol. Therefore, when used to make rPET, the rBHET yields approximately 20% less the amount of rPET as compared to the amount of vPET made using a PTA-based oligomer (formed through an esterification reaction of purified terephthalic acid with ethylene glycol), for comparable processes.

In the present disclosure, it is unexpectedly found that rBHET or a higher molecular weight oligomer derived from rBHET can be hydrolysed to produce an oligomeric PET substrate having an increased reactivity as compared to unmodified rBHET. Specifically, water is added to and reacted with rBHET or a higher molecular weight oligomer derived from rBHET to produce an oligomeric PET substrate. This oligomeric PET substrate is shown to have an increased reactivity as compared to unmodified oligomer, i.e., rBHET. Therefore, aspects of the present disclosure relate to a method for producing an oligomeric PET substrate by reacting rBHET or a higher molecular weight oligomer derived from rBHET with water.

The oligomeric PET substrate is represented by Formula I:

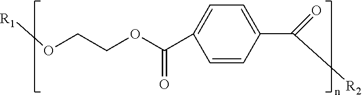

In embodiments, either end of Formula I may be a carboxyl end group or a hydroxyl end group. Therefore, either R1 or R2 may be a carboxyl end group or a hydroxyl end group. As described herein, Formula I has an optimum ratio of hydroxyl end group: carboxyl end group of typically between 1.66 and 6.66, and preferably between 2.22 and 4.0. The degree of polymerisation (Dp) or number of repeat units that exist in the oligomeric PET substrate may vary depending on whether rBHET or a higher molecular weight oligomer derived from rBHET is reacted with water to prepare the PET substrate. When rBHET is reacted with water, the degree of polymerisation (Dp) may be between 1 and 10, more typically between 3 and 7, and preferably 6. When a higher molecular weight oligomer derived from rBHET is reacted with water, the degree of polymerisation (Dp) may be between 20 and 50, and preferably between 25 and 35. In addition to being characterised by the degree of polymerisation (Dp) and the ratio of hydroxyl end group: carboxyl end group, the oligomeric PET substrate is also characterised by its carboxyl acid end group concentration, referred to herein as CEG. The CEG (units are mols acid ends/te of material) may vary depending on whether rBHET or a higher molecular weight oligomer derived from rBHET is reacted with water to prepare the PET substrate. When rBHET is reacted with water, the CEG may typically be between 300 and 1500, and preferably between 500 and 1200 or even between 700 and 1100. When a higher molecular weight rBHET oligomer is reacted with water, the CEG may be from 40 to 200, and preferably from 150 to 190.

In one non-limiting embodiment, the oligomeric PET substrate comprises a hydroxyl end group: carboxyl end group ratio of between 1.66 and 6.66, a Dp of between 4 and 7 and a CEG of between 700-1100 mols acid ends/te of material.

In another non-limiting embodiment, the oligomeric PET substrate comprises a hydroxyl end group: carboxyl end group ratio of between 1.66 and 6.66, a Dp of between 25 and 35 and a CEG of between 150 and 190 mols acid ends/te of material.

The source of the benefit associated to the optimised end group ratio is found in the balance of the reaction rates for esterification over polycondensation, the relative partial pressures of the condensation products, i.e. of water and ethylene glycol, and the balance of the chemical equilibrium constants of esterification as compared with polycondensation. This balance results in a natural optimum in the range of 2.22 to 4.0 as specified earlier.

In one non-limiting embodiment, the water is added to the rBHET in the range of 2 wt % to 20 wt %, and preferably in the range of Swt % to 10 wt %, with respect to the final PET polymer.

In another non-limiting embodiment, the water is added to the higher molecular weight rBHET oligomer in the range of 0.1 wt % to 2 wt %, and preferably in the range of 0.1 wt % to 0.5 wt %, with respect to the final PET polymer.

In one non-limiting embodiment, the rBHET is reacted with water at a temperature between 120° C. and 300° C., and preferably between 150° C. and 270° C.

In another non-limiting embodiment, the higher molecular weight oligomer derived from rBHET is reacted with water at a temperature between 270° C. and 300° C., and preferably between 285° C. and 295° C.

In one non-limiting embodiment, the rBHET is melted prior to addition to the reaction zone. The water and rBHET may be injected separately into the reaction zone or may be combined upstream of the reaction zone. The reaction zone precedes the injection of additives into said process. The residence time in the reaction zone may be from 30 minutes to 120 minutes, and preferably from 40 to 50 minutes.

In one non-limiting embodiment, the rBHET is reacted with water at a pressure from 3 barg to 30 barg. In another non-limiting example, the higher molecular weight oligomer derived from rBHET is reacted with water at a pressure of between 10 barg to 50 barg. This pressure is typically created in the reaction zone, for example a line reactor. The line reactor provides residence time at temperature to complete the reaction of the rBHET or higher molecular weight oligomer derived from rBHET with the water. In terms of the examples. it refers to the oligomer hold period.

In one non-limiting embodiment, the water added is added to a reaction zone after a prepolymerisation reactor.

In one non-limiting embodiment, the water added is added to a reaction zone after an intermediate polymerisation reactor.

In one non-limiting embodiment, the water is added to the base of continuous DMT ester exchange reactor with a titanium alkoxide catalyst.

The reaction may be catalysed or uncatalyzed, depending on the composition of the PCR-flake that was used to make the rBHET. In one non-limiting embodiment, the rBHET or higher molecular weight rBHET oligomer and water are reacted with an exogenously added catalyst. A post-consumer PET-containing waste material or PCR-flake may include latent catalyst as a result of its manufacturing process. Therefore, in some embodiments the rBHET derived from PCR flake may have sufficient endogenous catalyst. Nevertheless, additional exogenous catalyst may still be added where desirable. Non-limiting examples of catalysts that may be added to the reaction include catalysts including antimony, titanium, zinc, manganese, germanium, aluminium and tin. These may be selected from an antimony-containing catalyst, a titanium-containing catalyst, a zinc-containing catalyst, an acetate-containing catalyst, a manganese-containing catalyst, a germanium-containing catalyst, an aluminium-containing catalyst or a tin-containing catalyst. These may be, for example, antimony trioxide, antimony glycolate, antimony triacetate, titanium alkoxide, zinc acetate or manganese acetate. Such catalysts are added to the reaction zone typically known as the esterification unit. A titanium-containing catalyst is typically added at 2-100 ppm, and preferably around 10 ppm, with regard to final PET polymer. All other catalysts (except a titanium-containing catalyst is typically added at 40-300 ppm, preferably around 240 ppm.

In some non-limiting embodiments, the oligomeric PET substrate is used in a rPET manufacturing process, one that had previously been designed to synthesise vPET but which has been retrofitted to make rPET. In an alternative non-limiting embodiment, the oligomeric PET substrate is used in a rPET manufacturing process that was specifically designed from the outset to make rPET.

The present disclosure also relates to an oligomeric PET substrate produced by or obtainable by a method as described herein. In one non-limiting embodiment, the present disclosure relates to an oligomeric PET substrate produced by using rBHET derived from PCR-flake. In another non-limiting embodiment, the disclosure relates to an oligomeric PET substrate produced by using vBHET derived from vDMT (virgin dimethylterephthalate). In yet another non-limiting embodiment, the disclosure relates to an oligomeric PET substrate produced by using a combination of rBHET derived from PCR-flake and vBHET derived from vDMT.

In some embodiments, the oligomeric PET substrate has a structure according to Formula I:

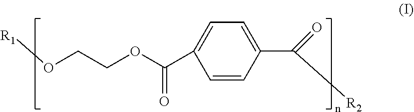

wherein R1 is a carboxyl end group or a hydroxyl end group, R2 is a carboxyl end group or a hydroxyl end group, and n is a degree of polymerisation, and wherein the oligomeric PET substrate is represented by two or more of the following characteristics:
i) n is a degree of polymerisation of 1 to 10;
ii) a CEG (mols acid ends/te of material) of from 300 to 1500; and
iii) a hydroxyl end group/carboxyl end group ratio in the range of 1.66 to 6.66.

In some embodiments, the oligomeric PET substrate is represented by the following characteristics: (i) n is a degree of polymerisation of 1 to 10 and (ii) a CEG (mols acid ends/te of material) of from 300 to 1500. In some embodiments, the oligomeric PET substrate is represented by the following characteristics: (i) n is a degree of polymerisation of 3 to 7 and (ii) a CEG (mols acid ends/te of material) of from 700 to 1100.

In some embodiments, the oligomeric PET substrate has a structure according to Formula I:

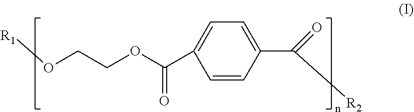

wherein R1 is a carboxyl end group or a hydroxyl end group, R2 is a carboxyl end group or a hydroxyl end group, and n is a degree of polymerisation, and wherein the oligomeric PET substrate is represented by two or more of the following characteristics:
i) n is a degree of polymerisation of 20 to 50;
ii) a CEG (mols acid ends/te of material) of from 40 to 200; and
iii) a hydroxyl end group/carboxyl end group ratio in the range of 1.66 to 6.66.

In some embodiments, the oligomeric PET substrate is represented by the following characteristics: (i) n is a degree of polymerisation of 20 to 50 and (ii) a CEG (mols acid ends/te of material) of from 40 to 200. In some embodiments, the oligomeric PET substrate is represented by the following characteristics: (i) n is a degree of polymerisation of 25 to 35 and (ii) a CEG (mols acid ends/te of material) of from 150 to 190.

A further aspect of the present disclosure also relates to PET polymer manufactured in a polymerisation process using oligomeric PET substrate produced by or obtainable by a method as described herein. The PET polymer may be in a range of 0-100% rPET. Therefore, the PET polymer may be fully virgin PET (produced from 100% vBHET which is itself derived from vDMT), fully recycled PET (produced from 100% rBHET), or it may comprise a mixture of vPET and rPET.

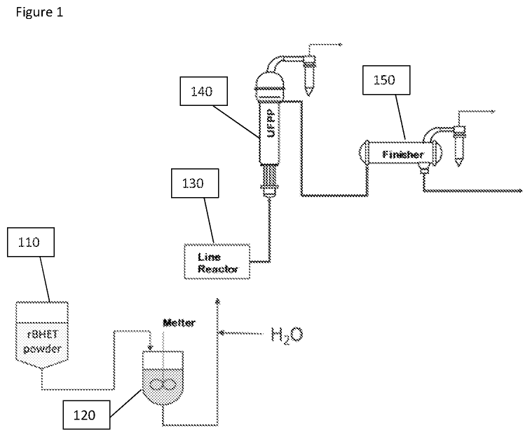

Referring to FIG. 1, a system according to one aspect of the present disclosure is shown for the production of an oligomeric PET substrate from a rBHET powder stored in a hopper 110. In the system shown, the rBHET powder is fed from the hopper 110 to a melting vessel 120, where the rBHET powder is melted and stirred. The molten rBHET is then mixed with water and the mixture is supplied to a reaction zone 130, also known as line reactor 130. The reaction zone 130 is maintained under conditions such that the rBHET reacts with the water to produce an oligomeric PET substrate. The effluent from the reaction zone 130 is then fed firstly to a pre-polymeriser vessel 140 and then to a finisher vessel 150 to increase a degree of polymerisation of the monomer.

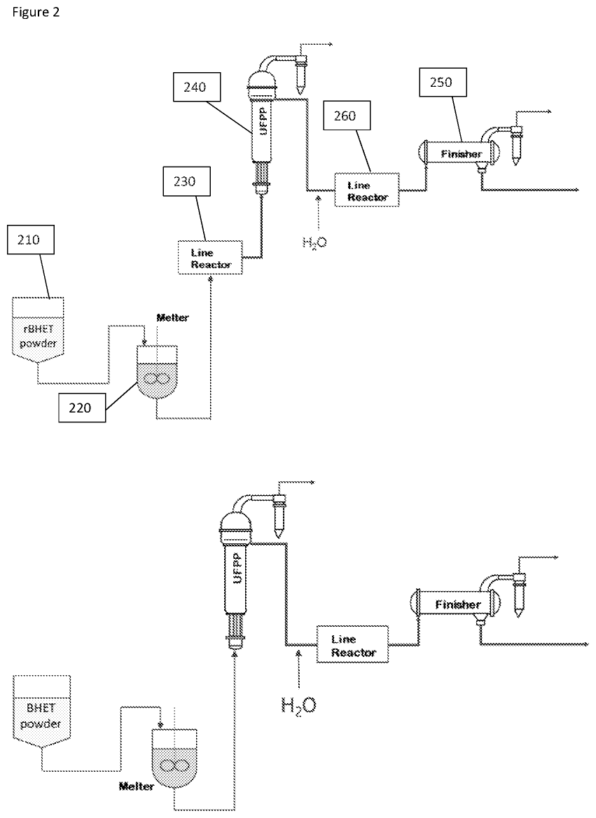

Referring to FIG. 2, a system according to one aspect of the present disclosure is shown for the production of an oligomeric PET substrate from a rBHET powder stored in a hopper 210. In the system shown, the rBHET powder is fed from the hopper 210 to a melting vessel 220, where the rBHET powder is melted and stirred. The mixture is pumped to a pre-polymeriser vessel (UFPP) 240. Water is then added to the effluent from pre-polymeriser vessel (UFPP) 240 and conveyed to reaction zone 260, also known as line reactor 260. The reaction zone 260 is maintained under conditions such that the rBHET catalytically reacts with the water to produce an oligomeric PET substrate. The effluent from the reaction zone 260 is then fed to a finisher vessel 250 to increase a degree of polymerisation of the monomer.

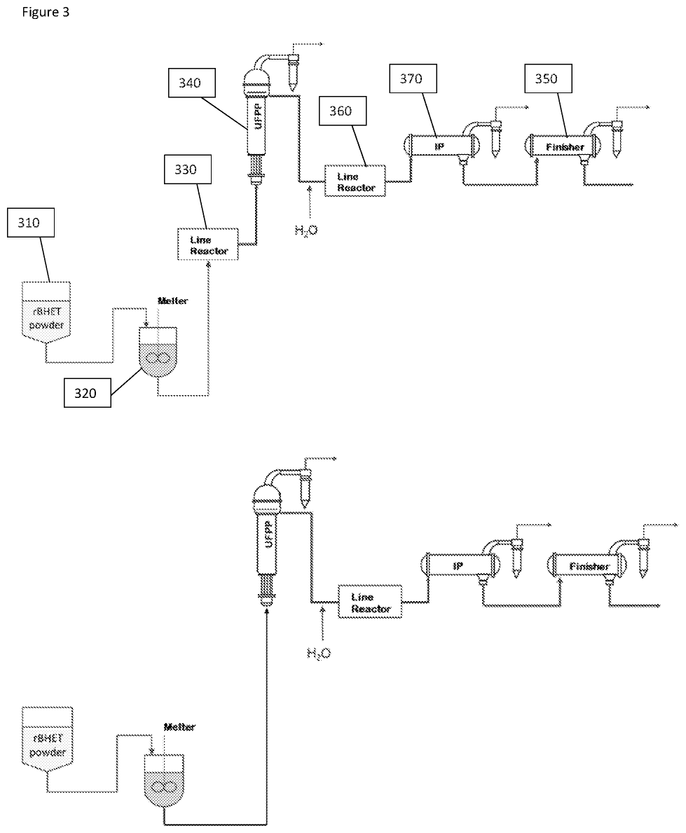

Referring to FIG. 3, a system according to one aspect of the present disclosure is shown for the production of an oligomeric PET substrate from a rBHET powder stored in a hopper 310. In the system shown, the rBHET powder is fed from the hopper 310 to a melting vessel 320, where the rBHET powder is melted and stirred. The mixture is pumped to a pre-polymeriser vessel (UFPP) 340. Water is then added to the effluent from pre-polymeriser vessel (UFPP) 340 and conveyed to reaction zone 360, also known as line reactor 360. The reaction zone 360 is maintained under conditions such that the rBHET catalytically reacts with the water to produce an oligomeric PET substrate. The effluent from the reaction zone 360 is then fed to an intermediate polymeriser (IP) 370 and then to a finisher vessel 350 to increase a degree of polymerisation of the monomer.

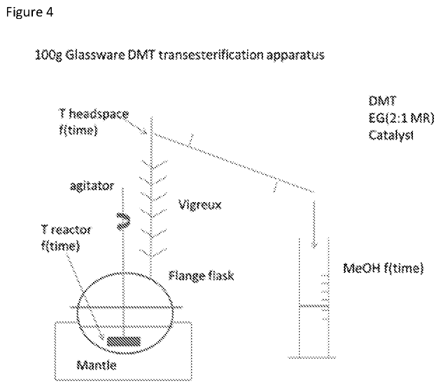

Referring to FIG. 4, a typical laboratory apparatus designed to demonstrate the hydrolysis of BHET from a DMT transesterification reaction is shown.

Referring to FIG. 5, a system according to one aspect of the present disclosure is shown for the production of an oligomeric PET substrate from BHET derived from DMT. DMT and ethylene glycol plus catalyst are added to Ester Exchange column 510. Water is added to the effluent (BHET) from Ester Exchange column 510 and conveyed to reaction zone 520, also known as line reactor 520. The reaction zone 520 is maintained under conditions such that the BHET catalytically reacts with the water to produce an oligomeric PET substrate. The effluent from the reaction zone 520 is then fed to a pre-polymeriser vessel (UFPP) 530 and then fed to a finisher vessel 540 to increase a degree of polymerisation of the monomer.

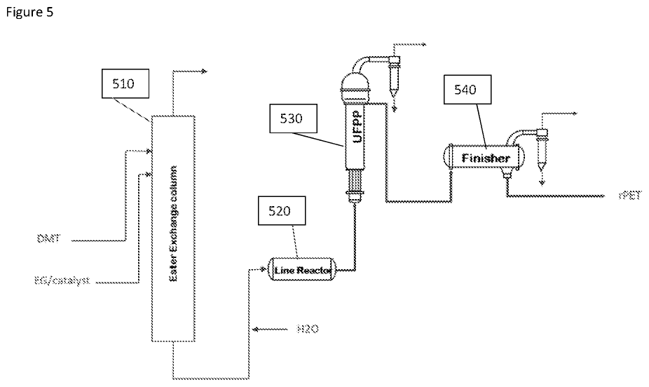

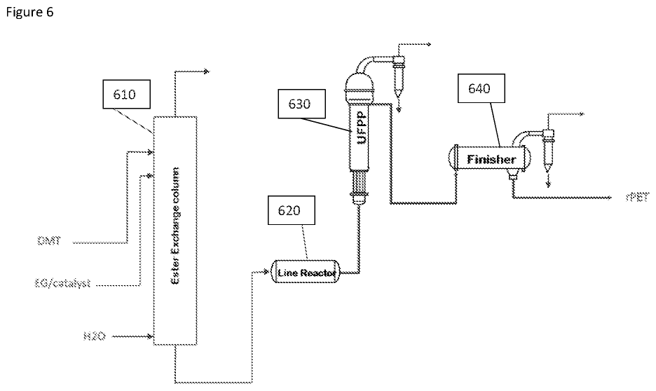

Referring to FIG. 6, a system according to one aspect of the present disclosure is shown for the production of an oligomeric PET substrate from BHET derived from DMT. DMT and ethylene glycol plus catalyst and water are added to Ester Exchange column 610. The effluent (BHET) from the Ester Exchange column 610 is conveyed to reaction zone 620, also known as line reactor 620. The reaction zone 620 is maintained under conditions such that the BHET catalytically reacts with the water to produce an oligomeric PET substrate. The effluent from the reaction zone 620 is then fed to a pre-polymeriser vessel (UFPP) 630 and then fed to a finisher vessel 640 to increase a degree of polymerisation of the monomer.

### EXAMPLES

Aspects of the disclosure are demonstrated by process modelling examples of continuous polymerisation (CP) operation which illustrate the predicted impact of water to bis-hydroxyethylene terephthalate (BHET).

Separately the methods of the disclosure have also been demonstrated on a 20L (litre) semi-works scale batch reactor using the following experimental protocol.

Typically, either 8 kg of PTA-based oligomer or 10.58 kg of BHET were charged to the reactor under ambient conditions along with sufficient antimony trioxide catalyst to achieve 280 ppm Sb (as element), cobalt acetate tetrahydrate to achieve 40 ppm Co (as element), and triethyl phosphate (TEP) to achieve 20 ppm P (as element). As per the detailed examples below other additives were added as described. The reactor was then isolated under a nitrogen blanket and heat applied. The reactor temperature setpoint was then set to 260° C., and as the content's temperature increased, the reactor pressure rose naturally as a consequence of the vapour pressure of the water and ethylene glycol. During this time and throughout this initial period, the contents were agitated at 50-1200 rpm. Once 260° C. had been established, the reactor was held for the pre-determined time, typically 30 to 60 minutes, before the pressure was released to atmospheric pressure and an oligomeric liquid sample taken. The vapours released during the pressure let down were condensed and collected in a receiving vessel. Once the oligomeric sample had been collected, vacuum was applied to the reactor stepwise from 1000 millibar absolute (mBara) to full vacuum, typically less than 2 mBara, in 250 mBara steps with 15 minutes per step. At the same time the reactor temperature setpoint was raised to 290° C. The reactor temperature setpoint was achieved by the end of the vacuum let down, typically after 60 minutes. The following period is referred to as the polycondensation time when the contents are held at 290° C., under full vacuum and agitated at 100 rpm. These conditions were maintained until the agitator torque reached a predetermined value of 15 Nm, associated with an intrinsic viscosity (iV) of 0.54 deciliters per gram (dl)/g at which point the vacuum was released and the agitator stopped to degas the resulting polymer. Throughout the volatiles were condensed and collected as before. When degassing was complete, typically after 10 minutes, the molten polymer was discharged by 2 barg overpressure and pelletised via a cooling trough.

The resulting polymer was then subjected to various standard PET analytical procedures including iV, carboxyl end group analysis (COOH), diethylene glycol analysis (DEG), CIE color analysis and X-ray fluorescence (XRF) analysis for metals content.

### Comparative Example 1

| Parameter | Value | Units |
|---|---|---|
| BHET | 8.0 | kg |
| H2O | 0.0 | kg |
| PTA | 0.0 | kg |
| CoAc•4H2O | 1.36 | g |
| TEP | 0.94 | g |
| Oligomer hold | | |
| Temp | 250 | ° C. |
| Pressure | 1.9 | barg |
| time | 40 | mins |
| Oligomer COOH | 40.7 | microeq/g |
| Polymerisation | | |
| Temp | 290 | ° C. |
| Pressure | 1.5 | mbara |
| time | 75 | mins |
| iV | 0.549 | dl/g |
| COOH | 30.7 | microeq/g |
| Sb | 361 | ppm |
| P | 15.7 | ppm |
| Co | 49.2 | ppm |
| L | 45.61 | CIE |
| b | 11.5 | CIE |

In Comparative Example 1, 8.0 kg of rPET sourced BHET was polymerised at 290° C. As can be seen in the table the polymer made had a COOH value of 30.7 microequivalents/g, an iV of 0.549dl/g, an L* color of 45.61 and a b* color of 11.5. The oligomer COOH number quoted in the table is for the starting material. The polymerisation time was 75 minutes.

### Comparative Example 2

| Parameter | Value | Units |
|---|---|---|
| PTA oligomer | 8.0 | kg |
| H2O | 0.0 | kg |
| PTA | 0.0 | kg |
| CoAc•4H2O | 1.36 | g |
| TEP | 0.94 | g |
| Oligomer hold | | |
| Temp | 250 | ° C. |
| Pressure | 2.8 | barg |
| time | 50 | mins |
| Oligomer COOH | 924 | microeq/g |
| Polymerisation | | |
| Temp | 290 | ° C. |
| Pressure | 1.8 | mbara |
| time | 95 | mins |
| iV | 0.541 | dl/g |
| COOH | 26.4 | microeq/g |
| Sb | 274 | ppm |
| P | 55 | ppm |
| Co | 39 | ppm |
| L | 63.99 | CIE |
| b | 9.89 | CIE |

In Comparative Example 2, 8.0 kg of commercial-scale PTA-based oligomer was polymerised at 290° C. As can be seen in the table above, the polymer made had a COOH value of 26.4 microequivalents/g, an iV of 0.541dl/g, an L* color of 63.99 and a b* color of 9.89. The oligomer COOH number quoted in the table is for the starting material. The polymerisation time was 95 minutes.

### Comparative Example 3

| Parameter | Value | Units |
|---|---|---|
| PTA | 6.92 | kg |
| EG | 3.62 | kg |
| H2O | 0.0 | kg |
| PTA | 0.0 | kg |
| CoAc•4H2O | 1.36 | g |
| TEP | 0.94 | g |
| Oligomer hold | | |
| Temp | 250 | ° C. |
| Pressure | 1.9 | barg |
| time | 40 | mins |
| Oligomer COOH | | microeq/g |
| Polymerisation | | |
| Temp | 290 | ° C. |
| Pressure | 1.5 | mbara |
| time | 75 | mins |
| iV | 0.535 | dl/g |
| COOH | 30.9 | microeq/g |
| Sb | 211 | ppm |
| P | 11 | ppm |
| Co | 27.5 | ppm |
| L | 59.45 | CIE |
| b | 12.56 | CIE |

In Comparative Example 3, 6.92 kg of vPTA was reacted with 3.62 kg of ethylene glycol at 246° C. for nine hours. The pressure of the sealed autoclave was allowed to rise naturally as esterification took place but was vented periodically from 9 barg down to 4 barg to allow the release of water. When no further pressure rise was observed, this indicated that esterification was complete, and the vessel was allowed to cool and the additives charged as in the previous examples. The resulting oligomer was then polymerised at 290° C. As can be seen in the table the polymer made had a COOH value of 30.9 microequivalents/g, an iV of 0.535dl/g, an L* color of 59.45 and a b* color of 12.56. No oligomer COOH number is available for this example. The polymerisation time was 75 minutes.

### Example 4

| Parameter | Value | Units |
|---|---|---|
| BHET | 10.58 | kg |
| H2O | 0.26 | kg |
| PTA | 0.0 | kg |
| CoAc•4H2O | 40 | ppm |
| TEP | 20 | ppm |
| Oligomer hold | | |
| Temp | 260 | C. |
| Pressure | 7.3 | barg |
| time | 55 | mins |
| Oligomer COOH | 535 | microeq/g |
| Polymerisation | | |
| Temp | 290 | C. |
| Pressure | 1.6 | mBara |
| time | 70 | mins |
| iV | 0.537 | dl/g |
| COOH | 21.5 | microeq/g |
| Sb | 325 | ppm |
| P | 12.6 | ppm |
| Co | 37.7 | ppm |
| L | 42.06 | CIE |
| b | 9.43 | CIE |

In Example 4, 0.26 kg of water was added to 10.58 kg of rPET sourced BHET and held at 260° C. for 55 mins before being polymerised at 290° C. As can be seen in the table the polymer made had a COOH value of 21.5 microequivalents/g, an iV of 0.537dl/g, an L* color of 42.06 and a b* color of 9.43. The oligomer COOH number of 535 microquivalents/g is significantly higher than that of the starting material which is indicative of hydrolysis having taken place. The polymerisation time was 70 minutes. In this case and in subsequent examples Co and P were added as a premix solution in ethylene glycol (0.353 wt % Co, 0.204 wt % P).

### Example 5

Examples 5, 6 and 7 take the form of process model simulations of a three vessel CP process operating at 450 tonnes per day making a typical bottle resin grade PET. The reactor train comprises an Esterifier, UFPP and Finisher vessel. The process conditions used for the simulation are described below:

| Parameter | Value | Units |
|---|---|---|
| Esterifier | | |
| Feed mole ratio | 1.89 | moles EG:moles TA |
| Temperature | 270 | ° C. |
| Pressure | 0.1 | barg |
| Residence time | 199 | mins |
| Additives zone | | |
| Sb | 280 | ppm |
| P | 20 | ppm |
| Co | 40 | ppm |
| EG | 200 | kg/hr |
| Oligomer COOH | 815 | microeq/g |
| Oligomer OH/COOH | 3.63 | |
| UFPP | | |
| Temperature | 294 | ° C. |
| Pressure | 20 | mmHg |
| Residence time | 27.9 | mins |
| Finisher | | |
| Temperature | 293 | ° C. |
| Pressure | 2.29 | mmHg |
| Residence time | 49.5 | mins |
| iV | 0.56 | dl/g |
| COOH | 43.0 | microeq/g |
| L | 67.3 | CIE |
| b | −0.61 | CIE |

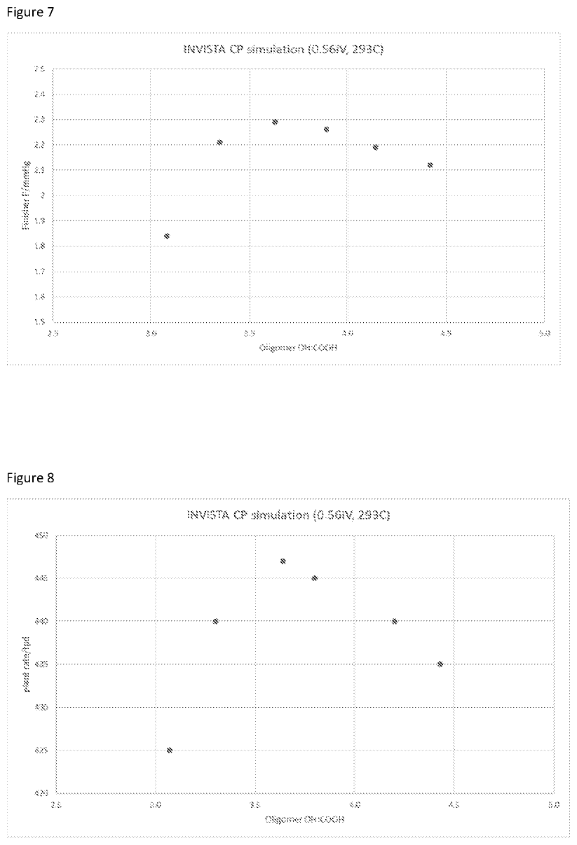

The key parameters of interest are the oligomer OH:COOH value of 3.63 and the 2.29 mmHg finisher pressure. Within the simulation, as the Esterifier feed mole ratio is increased, the effect is to alter the oligomer OH:COOH upwards and this impacts the reactivity and hence the predicted Finisher vacuum requirement as described in U.S. Pat. No. 3,551,386 A. This predicted effect is seen in FIG. 7.

An alternative way to represent this is to simulate the plant rate, or plant capacity as function of oligomer OH:COOH whilst maintaining a constant Finisher vacuum. This is shown in FIG. 8.

A change in oligomer OH:COOH from about 3.1 to about 3.6 is clearly worth about 5% in plant capacity.

### Example 6

The following is a predicted example of the same three vessel CP process as in Example 5, operating at 450 tonnes per day making the same typical bottle resin grade PET, but this time with a BHET feed.

| Parameter | Value | Units |
|---|---|---|
| Additives zone | | |
| BHET | 24800 | kg/hr |
| Sb | 280 | ppm |
| P | 20 | ppm |
| Co | 40 | ppm |
| EG | 0 | kg/hr |
| Oligomer COOH | 17 | microeq/g |
| Oligomer OH/COOH | 508 | |
| UFPP | | |
| Temperature | 294 | ° C. |
| Pressure | 20 | mmHg |
| Residence time | 27.9 | mins |
| Finisher | | |
| Temperature | 293 | ° C. |
| Pressure | 1.58 | mmHg |
| Residence time | 49.5 | mins |
| iV | 0.56 | dl/g |
| COOH | 14.0 | microeq/g |
| L | 59.2 | CIE |
| b | −1.76 | CIE |

The key parameters of interest are the very high 508 oligomer OH:COOH and the much reduced 1.58 mmHga Finisher pressure requirement. This oligomer OH:COOH is so large as to be off the chart above for capacity and in this case to raise the Finisher pressure to 2.3 mmHg, as in Example 5, the plant rate must be dropped to 390 tpd, representing a capacity reduction of some 20%. The deterioration in L* color is also significant.

### Example 7

Holding all the parameters in Example 6 constant and adding varying amounts of water to 24800 kg/h BHET, the following results are achieved:

| | wt % H2O | Oligomer | | Finisher | |
|---|---|---|---|---|---|
| H2O/kgph | added | COOH | Oligomer | COOH | Finisher P |
| added | (on PET) | microeq/g | OH:COOH | microeq/g | mmHg |
| 0 | 0 | 17 | 508.0 | 14.0 | 1.58 |
| 250 | 1.33 | 84 | 102.0 | 14.1 | 1.59 |
| 500 | 2.67 | 231 | 37.7 | 14.6 | 1.63 |
| 750 | 4.0 | 386 | 22.9 | 16.7 | 1.75 |
| 1000 | 5.33 | 538 | 16.7 | 22.0 | 2.0 |
| 1250 | 6.67 | 688 | 13.2 | 33.4 | 2.36 |
| 1500 | 8.0 | 834 | 11.1 | 54.7 | 2.36 |
| 1650 | 8.8 | 920 | 10.1 | 74.7 | 1.5 |

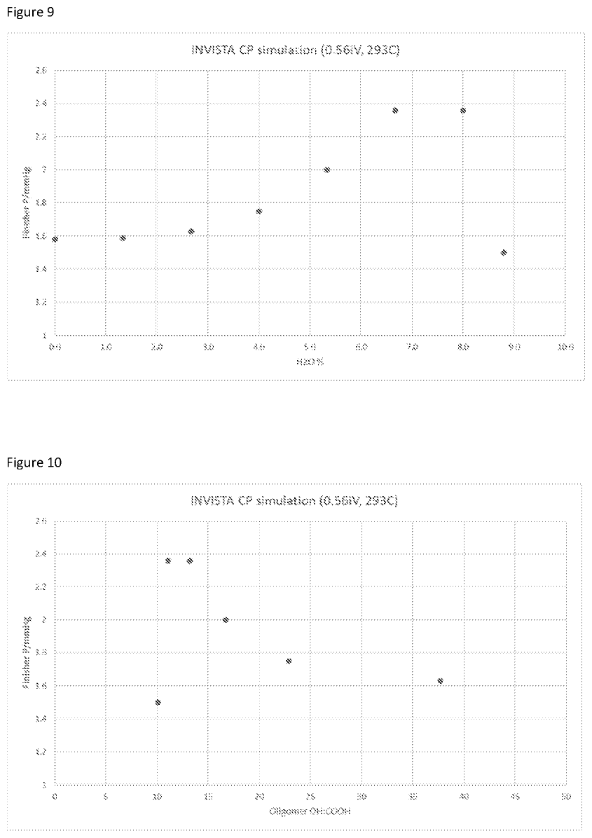

This is shown graphically as Finisher pressure required against % H₂O added in FIG. 9.

A clear optimum is seen at around 7.2% H₂O as represented by a maximum in the predicted Finisher vacuum requirement. Again, this is shown graphically as Finisher vacuum requirement against oligomer OH:COOH in FIG. 10. An optimum oligomer OH:COOH of around 12:1 is observed. Clearly, based on the improvement in Finisher vacuum requirement, the operation of the plant can be restored to the full 450 tpd with around 7% water added to the process.

### Example 8

Examples 8 and 9 are process model simulations of a three vessel CP process operating at 450 tonnes per day making a typical bottle resin grade PET with a BHET feed and a line reactor inserted between the UFPP and Finisher vessels. The process conditions used for the simulation are described below:

| Parameter | Value | Units |
|---|---|---|
| Additives zone | | |
| BHET | 24800 | kg/hr |
| Sb | 280 | ppm |
| P | 20 | ppm |
| Co | 40 | ppm |
| EG | 0 | kg/hr |
| Oligomer COOH | 16 | microeq/g |
| Oligomer OH/COOH | 556 | |
| UFPP | | |
| Temperature | 294 | ° C. |
| Pressure | 20 | mmHg |
| Residence time | 28.9 | mins |
| Line Reactor | | |
| H2O | 0 | kg/hr |
| LR oligomer COOH | 15.8 | microeq/g |
| LR oligomer OH/COOH | 28.9 | |
| LI oligomer iV | 0.189 | dl/g |
| Finisher | | |
| Temperature | 293 | ° C. |
| Pressure | 1.50 | mmHg |
| Residence time | 49.5 | mins |
| iV | 0.56 | dl/g |
| COOH | 15.9 | microeq/g |
| L | 58.8 | CIE |
| b | −2.91 | CIE |

The key parameters of interest are the line reactor oligomer OH:COOH value of 28.9 microeq/g, the line reactor oligomer iV of 0.189dl/g and the 1.50 mmHg finisher pressure.

### Example 9

In Example 9 60 kg/hr of water (0.32 wt % based on PET) is added to the post-UFPP line reactor.

| Parameter | Value | Units |
|---|---|---|
| Additives zone | | |
| BHET | 24800 | kg/hr |
| Sb | 280 | ppm |
| P | 20 | ppm |
| Co | 40 | ppm |
| EG | 0 | kg/hr |
| Oligomer COOH | 16 | microeq/g |
| Oligomer OH/COOH | 556 | |
| UFPP | | |
| Temperature | 294 | ° C. |
| Pressure | 20 | mmHg |
| Residence time | 28.9 | mins |
| Line Reactor | | |
| H2O | 60 | kg/hr |
| LR oligomer COOH | 169 | microeq/g |
| LR oligomer OH/COOH | 3.58 | |
| LR oligomer iV | 0.128 | dl/g |
| Finisher | | |
| Temperature | 293 | ° C. |
| Pressure | 0.81 | mmHg |
| Residence time | 49.5 | mins |
| iV | 0.56 | dl/g |
| COOH | 50 | microeq/g |
| L | 58.8 | CIE |
| b | −2.92 | CIE |

Now, the line reactor oligomer OH:COOH value decreases to 3.58 and the Finisher pressure falls to 0.81 mmHg. Therefore, even though the addition of water has improved the line reactor OH:COOH, the hydrolysis reaction has reduced the iV to 0.128 dl/g, meaning the Finisher has to work harder to maintain productivity. The wt % water required to reach the desired OH:COOH is much lower than Example 7; a consequence of the higher molecular weight line reactor oligomer.

### Example 10

Examples 10 and 11 are process model simulations of a four vessel CP process operating at 450 tonnes per day making a typical bottle resin grade PET with a BHET feed, a line reactor inserted after the UFPP, an Intermediate Polymeriser (IP) and a Finisher vessel. The process conditions used for the simulation are described below:

| Parameter | Value | Units |
|---|---|---|
| Additives zone | | |
| BHET | 24800 | kg/hr |
| Sb | 280 | ppm |
| P | 20 | ppm |
| Co | 40 | ppm |
| EG | 0 | kg/hr |
| Oligomer COOH | 16 | microeq/g |
| Oligomer OH/COOH | 556 | |
| UFPP | | |
| Temperature | 294 | ° C. |
| Pressure | 20 | mmHg |
| Residence time | 28.9 | mins |
| Line Reactor | | |
| H2O | 0 | kg/hr |
| LR oligomer COOH | 15.8 | microeq/g |
| LR oligomer OH/COOH | 28.9 | |
| LI oligomer iV | 0.189 | dl/g |
| Intermediate Polymeriser | | |
| Temperature | 285 | ° C. |
| Pressure | 5.81 | mmHg |
| Residence time | 41.7 | mins |
| iV target | 0.4 | Dl/g |
| Finisher | | |
| Temperature | 286 | ° C. |
| Pressure | 2.36 | mmHg |
| Residence time | 48.0 | mins |
| iV | 0.56 | dl/g |
| COOH | 17.0 | microeq/g |
| L | 58.8 | CIE |
| b | −2.4 | CIE |

The key parameters of interest are the line reactor oligomer OH:COOH value of 28.9 as in Example 8, the line reactor oligomer iV of 0.189dl/g, the 5.81 mmHg IP vacuum level and the 2.36 mmHg finisher pressure.

### Example 11

In Example 11, 60 kg/hr of water is added to the post-UFPP line reactor:

| Parameter | Value | Units |
|---|---|---|
| Additives zone | | |
| BHET | 24800 | kg/hr |
| Sb | 280 | ppm |
| P | 20 | ppm |
| Co | 40 | ppm |
| EG | 0 | kg/hr |
| Oligomer COOH | 16 | microeq/g |
| Oligomer OH/COOH | 556 | |
| UFPP | | |
| Temperature | 294 | ° C. |
| Pressure | 20 | mmHg |
| Residence time | 28.9 | mins |
| Line Reactor | | |
| H2O | 60 | kg/hr |
| LR oligomer COOH | 169 | microeq/g |
| LR oligomer OH/COOH | 3.58 | |
| LI oligomer iV | 0.128 | dl/g |
| Intermediate Polymeriser | | |
| Temperature | 285 | ° C. |
| Pressure | 7.2 | mmHg |
| Residence time | 37.9 | mins |
| iV target | 0.4 | dl/g |
| Finisher | | |
| Temperature | 293 | ° C. |
| Pressure | 2.94 | mmHg |
| Residence time | 47.9 | mins |
| iV | 0.56 | dl/g |
| COOH | 45 | microeq/g |
| L | 58.8 | CIE |
| b | −2.91 | CIE |

In Example 11, the line reactor oligomer OH:COOH value decreases to 3.58 as in Example 9 but this time the Finisher pressure increases to 2.94 mmHg. So, the addition of water has improved the line reactor OH:COOH but this time the use of an IP has enabled the Finisher to take full advantage of the improved reactivity. Once again, it is noted that the wt % water required to reach the desired OH:COOH is much lower than Example 7; a consequence of the higher molecular weight line reactor oligomer.

### Comparative Example 12

In Example 12, a laboratory glassware DMT transesterification using a titanium catalyst, TYZOR 131 organic titanate, is described. The apparatus used is as outlined in FIG. 4 and the experimental details are below. The DMT, ethylene glycol (EG) and catalyst are charged to the glass vessel and heated to a 200° C. setpoint. As the reagents heat up reaction begins to take place and methanol (MeOH) vapour is released overhead. As the temperature continues to rise EG vapour is also generated but is returned to the flask by the Vigreux column whilst the MeOH continues to the collection vessel via a condenser.

| Parameter | Value | Units |
|---|---|---|
| DMT | 100 | g |
| EG | 70.25 | g |
| Ti cat | 60 | ppm |
| Pressure | 1 | atm |
| Temperature profile | 22-220 | ° C. |
| MeOH removed | 37 | ml |
| Oligomer COOH | 16.8 | microeq/g |

The key parameters of interest are the oligomer COOH at 16.8 microequivalents/g and the amount of MeOH collected, in this case 37 ml.

### Example 13

In Example 13, the laboratory glassware DMT transesterification using a titanium catalyst, TYZOR 131 organic titanate, is repeated, but this time in the presence of 10 g of distilled water.

| Parameter | Value | Units |
|---|---|---|
| DMT | 100 | g |
| EG | 70.25 | g |
| H2O | 10 | g |
| Ti cat | 60 | ppm |
| Pressure | 1 | atm |
| Temperature profile | 22-220 | ° C. |
| MeOH removed | 38 | ml |
| Oligomer COOH | 273 | microeq/g |

As can be seen, the oligomer COOH is increased significantly to 273 microequivalents/g whilst still removing the MeOH. A titanium catalyst is required as a more traditional transesterification catalyst such as manganese acetate is deactivated in an aqueous environment.

1. A method for producing an oligomeric polyethylene terephthalate (PET) substrate for use in a recycled PET (rPET) manufacturing process, comprising:
reacting bis-hydroxylethyleneterephthalate, from either a recycled source or from vDMT, or a higher molecular weight oligomer derived from a similar BHET source with water to produce an oligomeric PET substrate represented by Formula I: 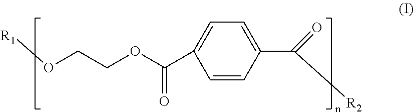
wherein R1 is a carboxyl end group or a hydroxyl end group, R2 is a carboxyl end group or a hydroxyl end group, and n is a degree of polymerisation.

2. The method according to claim 1, wherein when the method comprises reacting rBHET with water, the n is 1 to 10, preferably 3 to 7 and wherein when the method comprises reacting a higher molecular weight oligomer derived from rBHET with water, the n is 20 to 50, preferably 25 to 35.

3. The method according to claim 1, wherein when the method comprises reacting rBHET with water, the oligomeric PET substrate has a CEG (mols acid ends/te of material) of from 300 to 1500, preferably from 500 to 1200, more preferably from 700 to 1100 and wherein when the method comprises reacting a higher molecular weight oligomer derived from rBHET with water, the oligomeric PET substrate has a CEG (mols acid ends/te of material) of from 40 to 200, preferably from 150 to 190.

4. The method according to claim 1, wherein the oligomeric PET substrate has a hydroxyl end group: carboxyl end group ratio in a range of 1.66 to 6.66, preferably in a range of 2.22 to 4.0.

5. The method according to claim 1, wherein when the method comprises reacting rBHET with water, the water is added to the reaction zone in a range of 2 wt % and 20 wt %, preferably is in a range of 5 wt % to 10 wt % with respect to PET polymer and wherein when the method comprises reacting a higher molecular weight oligomer derived from rBHET with water, the water is added to the reaction zone in a range of 0.1 wt % and 2 wt %, preferably in a range of 0.1 wt % to 0.5 wt % with respect to PET polymer.

6. The method according to claim 1, wherein the said rBHET is reacted with the water at a temperature between 120 C to 300 C, preferably from 150 C to 270 C and the higher molecular weight oligomer derived from rBHET is reacted with water at a temperature from 270 C to 300 C, preferably from 285 C to 295 C.

7. The method according to claim 1, comprising a residence time in the reaction zone of between 30 minutes to 120 minutes, preferably from 40 to 50 minutes.

8. The method according to claim 1, wherein the rBHET is reacted with the water at a pressure between 3 barg to 30 barg and the higher molecular weight oligomer derived from rBHET is reacted with water at a pressure of between 10 barg to 50 barg.

9. The method according to claim 1, wherein the rBHET or a higher molecular weight oligomer derived from rBHET is reacted with water using at least one exogenously added catalyst selected from an antimony-containing catalyst, titanium-containing catalyst, a zinc-containing catalyst, an acetate-containing catalyst, a manganese-containing catalyst, a germanium-containing catalyst, an aluminium-containing catalyst and a tin-containing catalyst.

10. The method according to claim 9, wherein the catalyst comprises at least one of antimony trioxide, antimony glycolate, antimony triacetate, titanium alkoxide, zinc acetate and manganese acetate.

11. The method according to claim 1, wherein the oligomeric PET substrate is fed directly or indirectly into the rPET manufacturing process.

12. An oligomeric polyethylene terephthalate (PET) substrate produced by the method of claim 1.

13. The oligomeric PET substrate of claim 12 having the following structure: 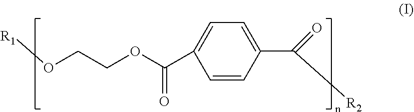
and further comprising any two of the following characteristics:
i) n is a degree of polymerisation of 1-10;
ii) a CEG (mols acid ends/te of material) of between 300 and 1500; or
iii) a hydroxyl end group: carboxyl end group ratio in a range of 1.66 to 6.66,
and wherein the oligomeric PET substrate is used in synthesis of a polymer comprising 0-100% rPET.

14. The oligomeric PET substrate of claim 12 having the following structure: 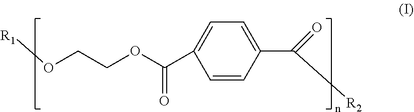
and further comprising any two of the following characteristics:
i) n is a degree of polymerisation of 20 to 50;
ii) a CEG (mols acid ends/te of material) of between 40 to 200; or
iii) a hydroxyl end group: carboxyl end group ratio in a range of 1.66 to 6.66,
and wherein the oligomeric PET substrate is used in synthesis of a polymer comprising 0-100% rPET.

15. A PET polymer made from 0-100% rPET, produced from the oligomeric PET substrate as claimed in claim 13.

16. A PET polymer made from 0-100% rPET, produced from the oligomeric PET substrate as claimed in claim 14.
